(19) United States
(12) Patent Application Publication
(10) Pub. No.: US 2025/0135256 A1
(43) Pub. Date: May 1, 2025

(54) NANOMATERIAL-BASED PROCESSING OF DYES AND ORGANIC COMPOUNDS

(71) Applicants: Drexel University, Philadelphia, PA (US); MURATA MANUFACTURING CO., LTD., Nagaokakyo-shi (JP)

(72) Inventors: Michel W BARSOUM, Moorestown, NJ (US); Hussein O. BADR, Philadelphia, PA (US); Kaho KOTANI, Nagaokakyo-shi (JP); Yuki KIMURA, Nagaokakyo-shi (JP); Akimaro YANAGIMACHI, Nagaokakyo-shi (JP); Takeshi TORITA, Nagaokakyo-shi (JP)

(21) Appl. No.: 18/837,169

(22) PCT Filed: Feb. 10, 2023
(86) PCT No.: PCT/US2023/062397

§ 371 Date: Aug. 8, 2024

Related U.S. Application Data
(60) Provisional application No. 63/309,411, filed on Feb. 11, 2022.

(51) Int. Cl. A62D 3/17; A62D 101/20

(52) U.S. Cl. CPC A62D 3/17; A62D 2101/20

(57) ABSTRACT

Provided is a method, comprising contacting a composition that comprises metal oxide nanofilaments to a dye and/or an organic compound under such conditions that the dye and/or the organic compound undergoes at least partial decomposition or degradation, the metal oxide nanofilaments the metal oxide nanofilaments optionally comprising titanium, the metal oxide nanofilaments optionally comprising carbon, the structure of the oxide nanofilaments optionally being an lepidocrocite structure; and further optionally comprising illuminating the composition and the dye and/or the organic compound. Also provided is a system, the system comprising a conduit and an amount of a composition that comprises a metal oxide nanofilaments, the conduit placing the composition into fluid communication with a process stream, the process stream comprising a dye and/or an organic compound.

### CROSS-REFERENCE TO RELATED MATTERS

The present application claims priority to and the benefit of U.S. patent application No. 63/309,411, “Nanomaterial-Based Processing Of Dyes And Organic Compounds” (filed Feb. 11, 2022). All foregoing applications are incorporated herein by reference in their entireties for any and all purposes.

### TECHNICAL FIELD

The present disclosure relates to the field of one-dimensional nanomaterials.

### BACKGROUND

Certain dyes and organic compounds can be undesirable, as they can cause health effects to those who come into contact with them and can pose other environmental risks. Accordingly, there is a long felt-need for methods of decomposing dyes and/or organic compounds.

### SUMMARY

In meeting the described long-felt needs, the present disclosure provides a method, comprising: contacting a composition that comprises metal oxide nanofilaments to a dye and/or an organic compound under such conditions that the dye and/or the organic compound undergoes at least partial decomposition or degradation, the metal oxide nanofilaments the metal oxide nanofilaments optionally comprising titanium, the metal oxide nanofilaments optionally with a one dimensional anatase structure, optionally comprising carbon, the structure of the oxide nanofilaments optionally being a lepidocrocite structure or even a 1-dimensional lepidocrocite (1DL) structure; and further optionally comprising illuminating the composition and the dye and/or the organic compound.

Also provided is a system, the system comprising a conduit and an amount of a composition that comprises metal oxide nanofilaments, the metal oxide nanofilaments optionally comprising titanium, the metal oxide nanofilaments optionally comprising carbon, the structure of the oxide nanofilaments optionally being an lepidocrocite structure, the conduit placing the composition into fluid communication with a process stream, the process stream comprising a dye and/or an organic compound.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1 provides (left panel) exemplary wavelength vs. absorbance data for an aqueous solution of 1DL and rhodamine 6G and exemplary time vs. remaining dye data for said aqueous solution of 1DL and rhodamine 6G.

FIG. 2 provides a calibration curve for an aqueous solution of rhodamine 6G

FIG. 3 provides (left panel) exemplary data for the suspended flocks of 1DL and rhodamine 6G in water before illumination and (right panel) after illumination

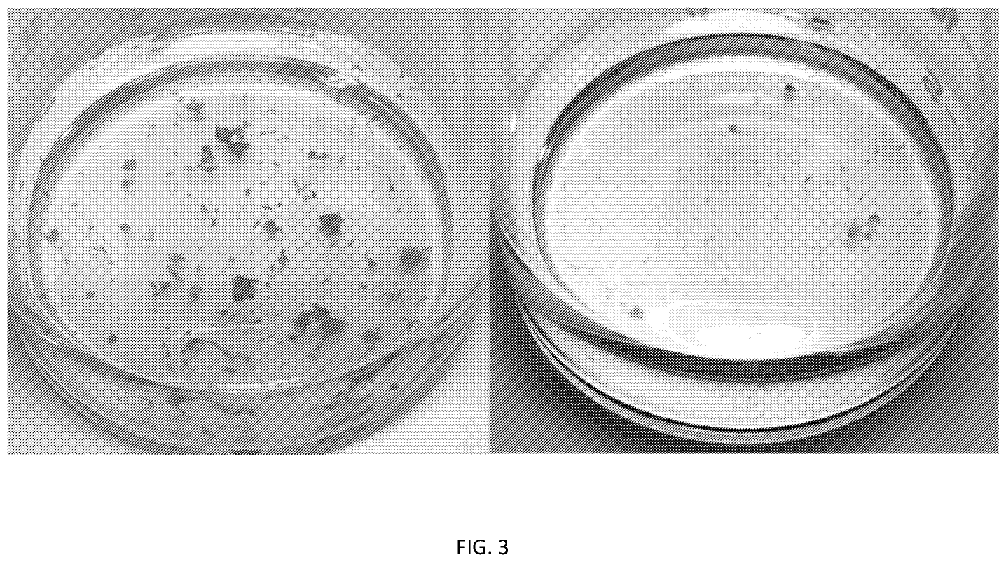

FIG. 4 provides a qualitative representation of the decolorization of rhodamine 6G in an aqueous solution of 1DL (right panel) before and (left panel) after filtering.

FIG. 5 provides wavelength vs. absorbance data for an aqueous solution of 1DL and rhodamine 6G at various times of exposure and filtered to remove all 1DL. This exemplary wavelength vs absorbance data corresponds to the solutions in FIG. 4 right panel.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints (e.g., “between 2 grams and 10 grams, and all the intermediate values includes 2 grams, 10 grams, and all intermediate values”). The endpoints of the ranges and any values disclosed herein are not limited to the precise range or value; they are sufficiently imprecise to include values approximating these ranges and/or values. All ranges are combinable.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4. Further, the term “comprising” should be understood as having its open-ended meaning of “including,” but the term also includes the closed meaning of the term “consisting.” For example, a composition that comprises components A and B may be a composition that includes A, B, and other components, but may also be a composition made of A and B only. Any documents cited herein are incorporated by reference in their entireties for any and all purposes.

### EXEMPLARY EMBODIMENTS

The following exemplary embodiments are illustrative only and does not serve to limit the scope of the present disclosure or the appended claims.

### EXAMPLES

### Example 1—Synthesis of 1DL

10 g of binary titanium precursor (e.g., TiB₂, TiN, TiC) powder was mixed with 100 mL of aqueous tetramethylammonium hydroxide (25 w/w) at 80° C. for 72 hours. It was washed with ethanol until the resulting supernatant solution was neutral. The neutral material was suspended in water resulting in a stable colloidal suspension.

### Example 2—Contacting of 1DL to Rhodamine 6G-Adsorption Regime

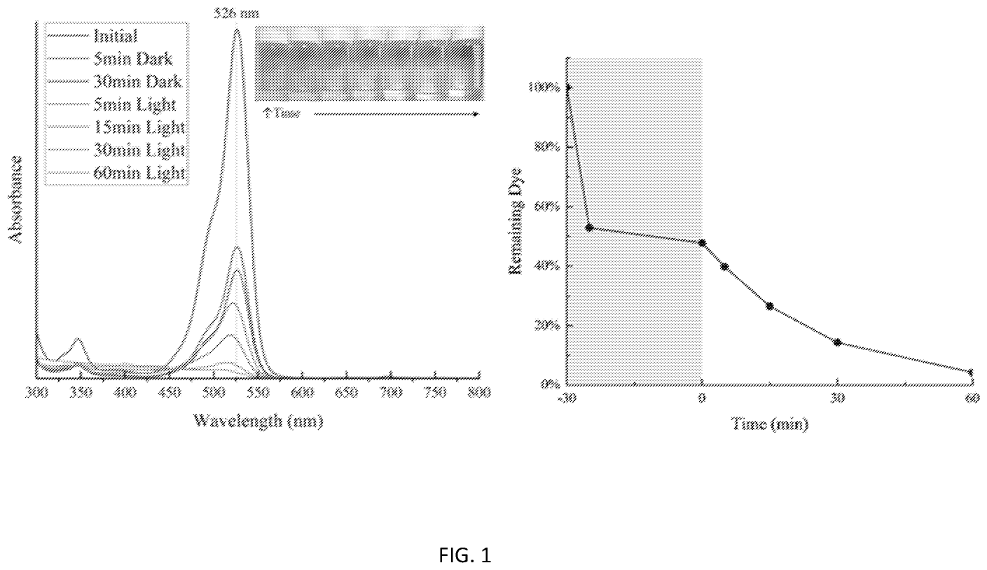

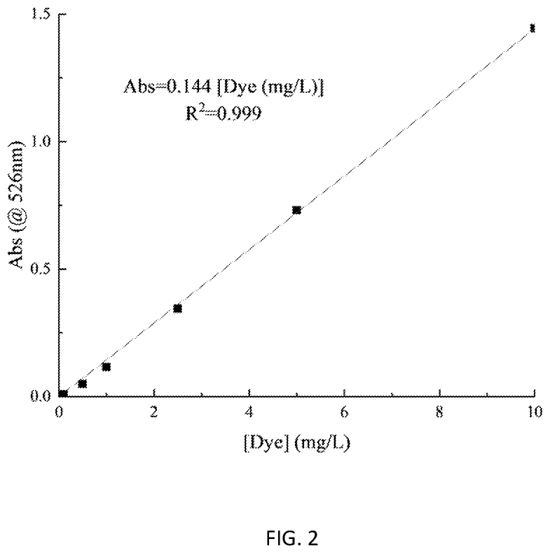

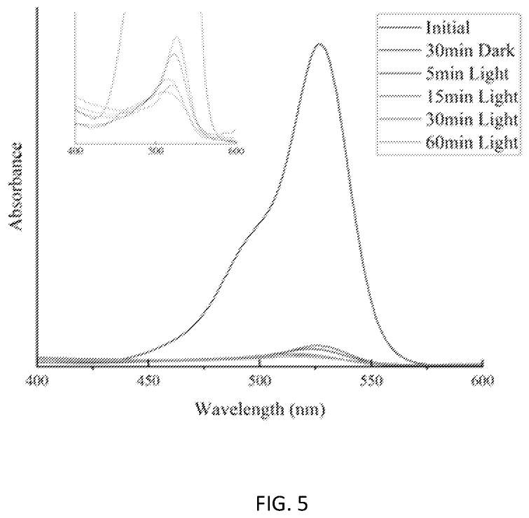

0.4 mL of 1 g/L colloidal 1DL is added to 38.8 mL of deionized water and mixed for 1 minute to combine. Then 0.8 mL of 500 mg/L dye solution is added to the aqueous 1DL. 1DL-Dye aggregates—or flocs—formed within 5 minutes of stirring at 400 RPM, as shown in FIG. 5. The flocs can be removed from solution with a 0.45 um PTFE syringe filter and the overall kinetics of dye removal can be monitored by ultraviolet-visible (UV Vis) light (FIG. 1—Dark) spectrometer utilizing a calibration curve (FIG. 2).

### Example 3—Contacting 1DL to Rhodamine 6G—Adsorption Regime

4 mL of 1 g/L colloidal 1DL is added to 35.2 mL of deionized water and mixed for 1 minute to combine. Then 0.8 mL of 500 mg/L dye solution is added to the aqueous 1DL. A 1DL-dye complex is formed immediately with stirring at 400 RPM, as shown in FIG. 6. The complex can be removed from solution by filtering with Celgard ion exchange membrane and the removal can be monitored by UV-Vis (FIG. 1—Dark) utilizing a calibration curve (FIG. 2).

### Example 4—Contacting 1DL with Rhodamine 6G-Degradation Under Solar Spectrum

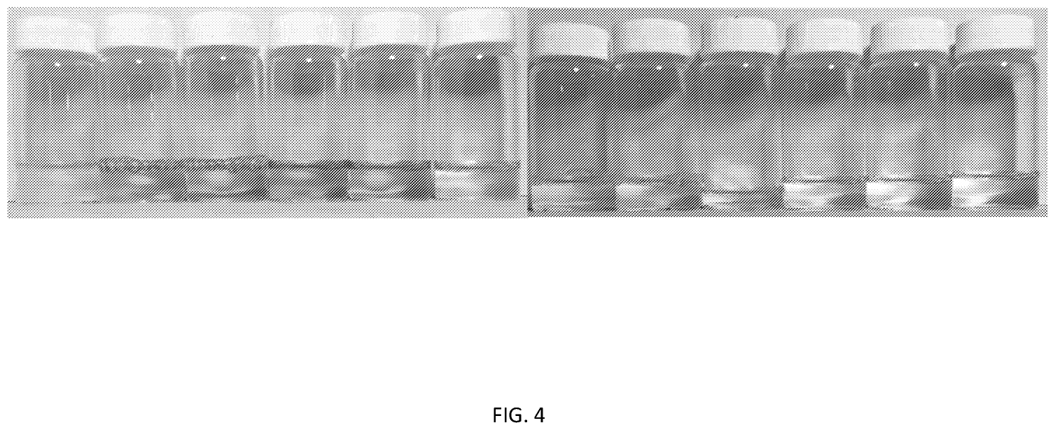

After the adsorption regime, a xenon lamp—a solar simulator—or sunlight, can be applied to the solution system. Without any aliquot removal, there is significant decolorization. The rate of decolorization is proportional to the ratio of 1DL to rhodamine 6G and power of the light source. FIG. 1 (inset) and FIG. 4 illustrate the decolorization as a function of irradiance time.

### Aspects

The following Aspects are illustrative only and do not limit the scope of the present disclosure or the appended claims. Any part or parts of any one or more Aspects can be combined with any part or parts of any one or more other Aspects.

Aspect 1. A method, comprising: contacting a composition that comprises metal oxide nanofilaments to a sample comprising a dye and/or an organic compound under such conditions that the dye and/or the organic compound associates with the composition; and the metal oxide nanofilaments nanofilaments optionally comprising titanium, the metal oxide nanofilaments optionally comprising carbon, the oxide nanofilaments optionally having an lepidocrocite structure.

The metal oxide nanofilaments can optionally have a titanium oxide lepidocrocite structure. The metal oxide nanofilaments can optionally be one dimensional nanofilaments (which can be lepidocrocite) with cross-sections that are 1 nm or smaller.

The association between the dye and/or an organic compound and the metal oxide nanofilaments can be an adsorption.

Titanium oxide nanofilaments are considered especially suitable. Example of one dimensional nanofilaments are described in Badr, et al., “Bottom-Up, Scalable Synthesis Of Anatase Nanofilament-Based Two-Dimensional Titanium Carbo-Oxide Flakes,” Materials Today 2021 (https://doi.org/10.1016/j.mattod.2021.10.033) and Badr, et al., “On the structure of one-dimensional TiO₂ lepidocrocite”, Matter 2023 (https://doi.org/10.1016/j.matt.2022.10.015). It should be understood that the nanofilaments can be comprised in the form of mesoporous materials (e.g., powders), in the form of sheets, and other forms. It should be understood that nanofilaments can be tubular in nature.

The composition and the dye and/or the organic compound can be present in a solvent, e.g., water. Other solvents (polar solvents, non-polar solvents, alcohols, and the like) can be used. The contacting can be at from about 20 to about 95° C., or from about 25 to about 75° C., or from about 30 to about 70° C., or from about 35 to about 65° C., or from about 40 to about 60° C., or from about 45 to about 55° C., even about 50° C. The contacting can be from, e.g., about 5 minutes to about 5 hours, from about 10 minutes to about 4.5 hours, from about 15 minutes to about 4 hours, from about 20 minutes to about 3.5 hours, from about 30 minutes to about 3 hours, from about 45 minutes to about 2 hours, or any combination or subrange thereof.

Aspect 2. The method of claim 1, further comprising effecting at least partial decomposition or degradation of the dye and/or the organic compound, further optionally comprising illuminating the composition and the dye and/or the organic compound. Without being bound to any particular theory or embodiment, the illumination can give rise to the at least partial decomposition or degradation of the dye and/or the organic compound.

Aspect 3. The method of claim 2, wherein the illuminating comprises xenon lamp illumination. Other forms of illumination, e.g., natural light, or UV light can also be used.

Aspect 4. The method of any one of claims 2-3, wherein the at least partial decomposition gives rise to one or more fragments. As an example, the fragments can be fragments of the dye and/or organic compound.

Aspect 5. The method of any one of claims 1-4, wherein the dye comprises any one or more of rhodamine 6G, methylene blue, methyl orange, and crystal violet. Other suitable dyes include, e.g., Alcian Blue 8GX, Alcian yellow GXS, Alizarin, Alizarin Red S, Alizarin yellow GG, Alizarin yellow R, Azophloxin, Bismarck brown R, Bismarck brown Y, Phenylene brown, Brilliant cresyl blue, Chrysoidine R, Chrysoidine Y, Congo red, Crystal violet, Ethyl Green, Fuchsin acid, Gentian violet, Janus green, Lissamine fast yellow, Malachite green, Martius yellow, Meldola blue, Metanil yellow, Methyl orange, Methyl red, Methylene blue, Naphthalene black, Naphthol green B, Naphthol yellow S, Orange G, Purpurin, Rose Bengal, Sudan II, Titan yellow, Tropaeolin O, Tropaeolin OO, Tropaeolin OOO, Victoria blue 4R, Victoria blue B, Victoria blue R, Xylene cyanol FF, or any combination thereof.

Aspect 6. The method of any one of claims 1-5, wherein the organic compound comprises any one or more of a benzene, a phenol, a phthalate, a methine, an azo, phthalocyanine, triarylmethane, and compounds that comprise an amino and/or a nitro group.

Aspect 7. The method of any one of claims 1-6, wherein the contacting is performed in a recycling manner.

Aspect 8. The method of any one of claims 1-7, wherein the contacting is performed in a single-pass manner.

Aspect 9. The method of any one of claims 1-8, further comprising determining a level of the dye and/or organic compound in the sample before contacting the sample and the composition comprising the metal oxide nanofilaments.

Aspect 10. The method of any one of claims 1-9, further comprising determining a level of the dye and/or organic compound in the sample after contacting the sample and the composition comprising the metal oxide nanofilaments.

Aspect 11. The method of any one of claims 9-10, further comprising effecting further contact between the sample and the composition comprising the metal oxide nanofilaments if the level is above a threshold level.

Aspect 12. The method of claim 11, wherein the level is determined spectroscopically.

Aspect 13. The method of claim 12, wherein the level is determined by comparing an absorbance at a wavelength to a standard.

Aspect 14. The method of claim 13, wherein the level is determined by comparing an absorbance at a first wavelength to an absorbance at a second wavelength.

Aspect 15. The method of any one of claims 2-14, further comprising collecting a product of the at least partial decomposition. The collection can be, e.g., by filtration or centrifugation.

Aspect 16. A system, the system comprising a conduit and an amount of a composition that comprises metal oxide nanofilaments, the conduit placing the composition into fluid communication with a process stream, the process stream comprising a dye and/or an organic compound. The system can be configured such that the dye and/or an organic compound associates, e.g., adsorbs to, with the metal oxide nanofilaments.

Suitable metal oxide nanofilaments are described elsewhere herein. The composition that comprises the metal oxide nanofilaments can be, e.g., an aqueous solution.

As one example, a cartridge of metal oxide nanofilaments can be placed so that the effluent stream from a chemical process plant runs through metal oxide nanofilaments, thereby affording the metal oxide nanofilaments an opportunity to adsorb/decompose dye and/or organic compounds that may be in the effluent. The system can also include a source of illumination (e.g., xenon lamp, UV light); without being bound to any particular theory, the illumination can effect improved decomposition performance by the metal oxide nanofilaments.

Aspect 17. The system of claim 16, wherein the system operates in a continuous manner.

Aspect 18. The system of claim 16, wherein the system operates in a batch or semi-batch manner.

As an example, an aqueous colloidal suspension of metal oxide nanofilaments can be added to a process stream (e.g., an effluent stream), thereby affording the metal oxide nanofilaments an opportunity to adsorb dye and/or organic compounds that may be in the process stream. The adsorbed material can then be separated by centrifugation or filtration or by allowing the adsorbed/deflocculated material to settle. The system can also include a source of illumination (e.g., a xenon lamp); without being bound to any particular theory, the illumination can decompose the adsorbed dye and/or organic compound from the metal oxide nanofilaments, allowing for re-addition, re-use, and/or recycling of the nanofilaments to the process stream, where the nanofilaments can adsorb further dye and/or organic compounds. In this manner, nanofilaments adsorb the dye, the dye is broken down into constituents, and then “clean” nanofilaments are re-introduced into the process stream to adsorb other dye in the process stream. Without being bound to any particular theory or embodiment, the foregoing method can be repeated such that a given dye is broken down into CO₂ and/or water and/or nitrogen and/or nitrates.

As an example, the disclosed methods can comprise (a) dye molecule adsorbs to nanostructure; (b) under illumination, the dye breaks into fragments and the fragments of the dye molecule can or not detach from nanostructure; (c) detached fragments of dye then re-adsorb to nanostructure; (d) under illumination, sub-fragments of dye to detach from nanostructure; (e) steps c and d repeat until all that remains of the dye are CO₂ and/or water and/or nitrogen and/or nitrate.

1. A method, comprising:
contacting a composition that comprises metal oxide nanofilaments to a sample comprising a dye and/or an organic compound under such conditions that the dye and/or the organic compound associates with the composition; and
the metal oxide nanofilaments optionally comprising titanium, the metal oxide nanofilaments optionally comprising carbon, and the oxide nanofilaments optionally having an lepidocrocite structure.

2. The method of claim 1, further comprising effecting at least partial decomposition or degradation of the dye and/or the organic compound, further optionally comprising illuminating the composition and the dye and/or the organic compound.

3. The method of claim 2, wherein the illuminating comprises xenon lamp illumination.

4. The method of claim 2, wherein the at least partial decomposition gives rise to one or more fragments.

5. The method of claim 1, wherein the dye comprises any one or more of rhodamine 6G, methylene blue, methyl orange, and crystal violet.

6. The method of claim 1, wherein the organic compound comprises any one or more of a benzene, a phenol, a phthalate, a methine, an azo, phthalocyanine, triarylmethane, and compounds that comprise an amino and/or a nitro group.

7. The method of claim 1, wherein the contacting is performed in a recycling manner.

8. The method of claim 1, wherein the contacting is performed in a single-pass manner.

9. The method of claim 1, further comprising determining a level of the dye and/or organic compound in the sample before contacting the sample and the composition comprising the metal oxide nanofilaments.

10. The method of claim 1, further comprising determining a level of the dye and/or organic compound in the sample after contacting the sample and the composition comprising the metal oxide nanofilaments.

11. The method of claim 9, further comprising effecting further contact between the sample and the composition comprising the metal oxide nanofilaments if the level is above a threshold level.

12. The method of claim 11, wherein the level is determined spectroscopically.

13. The method of claim 12, wherein the level is determined by comparing an absorbance at a wavelength to a standard.

14. The method of claim 13, wherein the level is determined by comparing an absorbance at a first wavelength to an absorbance at a second wavelength.

15. The method of claim 2, further comprising collecting a product of the at least partial decomposition.

16. A system, the system comprising a conduit and an amount of a composition that comprises metal oxide nanofilaments, the conduit placing the composition into fluid communication with a process stream, the process stream comprising a dye and/or an organic compound.

17. The system of claim 16, wherein the system operates in a continuous manner.

18. The system of claim 16, wherein the system operates in a batch or semi-batch manner.
